(19) United States
(12) Patent Application Publication
(10) Pub. No.: US 2025/0376812 A1
(43) Pub. Date: Dec. 11, 2025

(54) EXTRACTION OF SURFACE COMPOSITION FOR CLAY-LIKE ATHLETIC FIELDS

(71) Applicant: ROLAND TENNIS, LLC, Birmingham, AL (US)

(72) Inventor: Jake Dreher, Birmingham, AL (US)

(21) Appl. No.: 19/222,644

(22) Filed: May 29, 2025

Related U.S. Application Data
(60) Provisional application No. 63/657,427, filed on Jun. 7, 2024.

(51) Int. Cl. E01C 13/00; C04B 14/10; E01C 13/02

(52) U.S. Cl. CPC E01C 13/003; E01C 13/02; C04B 14/108

(57) ABSTRACT

A method of extracting surface composition for a clay-like athletic field is disclosed. The method includes extracting a by-product i.e., coal shale, which is a sedimentary rock that has undergone high-temperature combustion during the coal mining process. The coal shale is crushed to predefined size particles. The coal shale is dried for a predetermined time period. Subsequently, the dried coal shale is screened via mesh screens of different grain sizes to separate the dried shale for use as the surface composition for the clay-like athletic field, such as a clay tennis court. The coal shale is used in place of a traditional crushed brick.

### CROSS-REFERENCE TO RELATED APPLICATIONS

The present application claims priority to a U.S. Provisional Application No. 63/657,427, filed Jun. 7, 2024, which is incorporated herein in its entirety and referenced thereto.

### BACKGROUND OF THE INVENTION

### Field of the Invention

The present invention relates to athletic surfaces or fields, and in particular, relates to a method for constructing athletic fields such as tennis court surfaces using a byproduct of the coal mining industry, specifically burned-out coal shale.

### Description of the Prior Art

It is known that tennis courts are constructed using different surface materials depending on the playing dynamics. Examples of the tennis courts include clay courts, hard courts, and grass courts. The clay courts are popular due to their ability to provide traction, bouncing of a ball and distinct playing style when compared with other courts. Typically, crushed brick is used for constructing the clay courts. The crushed brick is also known as “red clay”. In order to obtain the crushed brick, bricks made from clay are fired in a kiln at very high temperatures. Once fired, the bricks are cooled down to hardened. Subsequently, the hardened bricks are crushed to break them into smaller pieces or fine-grade crushed brick suitable for use as surface composition for tennis courts.

FIG. 1 shows an exemplary environment 10 of a typical clay tennis court 12, in accordance with prior art. Clay tennis court 12 is made of a plurality of layers 14. Plurality of layers 14 present a first layer 20, a second layer 22, a third layer 24, a fourth layer 26 and a fifth layer 28. First layer 20 indicates a top layer consisting of a fine-grade crushed brick. Second layer 22 indicates an under-layer that sits underneath first layer 20. In one example, second layer 22 has a thickness of 4 centimeters (cm). Second layer 22 consists of crushed brick with an addition of raw clay. Here, the raw clay has binding characteristics allowing first layer 20 to sit on it. Third layer 24 indicates a ground layer that sits underneath second layer 22. In one example, the ground layer has a thickness of 4 cm with a grain size of 2-15 mm. Fourth layer 26 consists of crushed aggregate and sits underneath third layer 24. In one example, the crushed aggregate has a thickness of 5 centimeters (cm) with grain size of 3-15 mm. Fifth layer 28 consists of loose stones that act as a foundation for clay tennis court 12. As can be seen, fifth layer 28 sits underneath fourth layer 26. In one example, fifth layer 28 has a thickness ranging from 20 to 30 cm with a grain size of 40-70 mm.

In order to lay plurality of layers 14, at first, third layer 24, fourth layer 26, and fifth layer 28 are pressed and levelled to obtain the flatness needed. Subsequently, second layer 22 is laid over third layer 24. Further, first layer 20 is laid over second layer 22. The thickness of each layer can be changed depending on the need. Additionally, the number of layers needed may be modified depending on the need or type of materials used.

Several methods of constructing athletic fields including clay tennis courts have been disclosed in the past. One such example is disclosed in a U.S. Publication No. 20210071371, entitled “Sports flooring and method for providing a sports flooring” (“the '371 Publication”). The '371 Publication discloses a method for providing a sports flooring, in particular a clay court, a sand court or an ash court. The sports flooring comprises a top layer arranged above a dynamic layer. The method comprising providing a dynamic layer comprising a mixture of lava particles and/or limestone particles and/or clinker particles, and microporous zeolite mineral particles, wherein the microporous zeolite mineral particles are present in the amount of 4% to 65% of the total mass of the dynamic layer and wherein the grain size of the microporous zeolite mineral particles is between 0.4 mm and 12 mm, and applying a top layer on top of the dynamic layer.

Another example is disclosed in a U.S. Pat. No. 7,713,133, entitled “Surface composition for clay-like athletic fields” (“the '133 patent”). The '133 patent discloses a clay-like athletic surface compositions that utilize different types of glass cullet, such as container, ceramic, or plate glass, are provided. Preferably, recycled container-glass cullet between 1.4 millimeters and 20 microns in size is used to provide a slow playing, resilient surface good for a variety of athletic purposes, such as tennis, track and field, and bocce.

Another example is disclosed in a Chinese Pat No. 210,368,511, entitled “Laterite playground” (“the '511 patent”). The '511 patent discloses a red soil sport field, which can be used for constructing tennis courts, goal courts, softball courts, baseball courts and the like, and comprises a base layer, a stable layer, a red soil bottom layer, a red soil surface layer, a protective layer and drawing lines or installing permanent field lines which are sequentially paved on a field foundation from bottom to top, the base layer is composed of stubborn stone and sand and stone. The stable layer takes slag ash and lime (or red volcanic ash particles) as raw materials, the red soil bottom layer takes high-quality machine-selected crushed red soil, machine-made red sand, red brick powder and red volcanic ash as main raw materials, the red soil surface layer takes sieved or machine-crushed high-quality fine red soil, machine-made red sand and red brick powder and machine-selected red volcanic ash as raw materials, and the protective layer. The laterite playground constructed is low in maintenance cost, moderate in hardness, not easy to change and durable in use. In addition, when it rains or waters, the field will not become sticky, the anti-freezing and anti-cracking performance is good, and the service life is long.

Although the above discussed disclosures are useful, they have few problems. For example, the traditional way of constructing the clay tennis courts using the crushed brick requires high maintenance, requires significant water, and presents substantial costs associated with installation. In addition, the crushed brick has to undergo heating prior to adding a binder or binding agent to it for binding with the second layer. Further, the crushed brick is not readily available in some parts of the world thereby increasing the cost of using the crushed brick as the surface material for clay tennis courts. For instance, the red clay used in Europe costs three to four times in the United States, making it very expensive to use.

In addition, most of the clay tennis courts available in the United States are made using Rubico™, a type of tennis court surface, also known as green clay. Rubico is typically made from crushed metabasalt, which is a type of volcanic rock. Green clay courts come in greenish-brown color and have slightly different playing characteristics from that of red clay courts found in Europe. Green clay courts are harder and faster compared to traditional red clay courts made from crushed brick. In order to replicate the characteristics of red clay courts available in the Europe, American manufacturers tried to make red clay courts by dying more traditional American clays or Rubico to try to mimic the red clay courts seen in Europe. However, the red clay courts do not offer suitable playing conditions to that of the red clay courts found in Europe and are not easy to maintain.

Therefore, there is a need in the art to provide an innovative method for constructing athletic fields such as red tennis court surfaces using a byproduct of the coal mining industry, specifically burned-out coal shale which offers characteristics of the red clay courts.

### SUMMARY OF THE INVENTION

It is an object of the present invention to use a burned-out coal shale, a byproduct generated during the coal mining and combustion processes to create a clay tennis court surface that offers enhanced performance, cost efficiency, and sustainability.

It is another object of the present invention to provide a method of extracting a burned-out coal slate or coal shale, for use as a surface composition for a clay-like athletic field such as a clay tennis court.

In order to achieve one or more objects, the present invention provides a method of extracting surface composition for a clay-like athletic field. The method includes extracting a by-product i.e., coal shale. The coal shale is a sedimentary rock that has undergone high-temperature combustion during the coal mining process. The coal shale is crushed to predefined size particles. The coal shale is dried for a predetermined time period. Subsequently, the dried coal shale is screened via mesh screens of different grain sizes to separate the dried shale for use as the surface composition for the clay-like athletic field, such as a clay tennis court.

In one advantageous feature of the present invention, the coal shale is used in place of a traditional crushed brick. The inherent hardness and durability of the coal shale resulting from the high-temperature exposure, contribute to increased resistance against weathering and erosion. As a result, the life of the clay-like athletic field can be extended thereby reducing the need for frequent resurfacing and maintenance. Further, there is no need to heat/fire the coal shale at high temperatures as that of traditional crushed brick.

In another advantageous feature of the present invention, the coal shale is available as a byproduct of the coal mining industry in the regions with coal mining activities or abandoned coal mines. This reduces the cost of importing traditional crushed brick, which requires energy-intensive manufacturing processes. Further, the coal shale is repurposed to attain sustainable development and circular economy, contributing to the reduction of waste and environmental impact.

These and other objects of the present invention will be apparent from review of the following specification and the accompanying drawings.

### BRIEF DESCRIPTION OF THE DRAWINGS

FIG. 1 is an environment of a clay tennis court, in accordance with prior art.

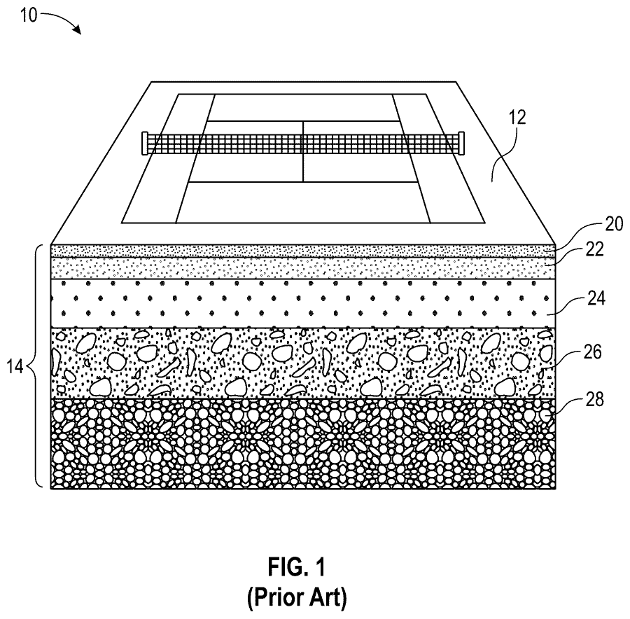

FIG. 2 is a schematic view of a clay-like athletic field having a plurality of layers, in accordance with one embodiment of the present invention.

FIG. 3 is a method of extracting surface composition for a clay-like athletic field, in accordance with one embodiment of the present invention.

### DETAILED DESCRIPTION OF THE PREFERRED EMBODIMENT

The detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed extracting surface composition for a clay-like athletic field. However, it will be apparent to those skilled in the art that the presently disclosed invention may be practiced without these specific details. In some instances, well-known structures and devices are shown in functional or conceptual diagram form in order to avoid obscuring the concepts of the presently disclosed extracting surface composition for a clay-like athletic field.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention describes extracting surface composition for a clay-like athletic field, it is to be further understood that numerous changes may arise in the details of the embodiments of extracting surface composition for a clay-like athletic field. It is contemplated that all such changes and additional embodiments are within the spirit and true scope of this invention.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the invention and are not intended to limit the scope of the invention.

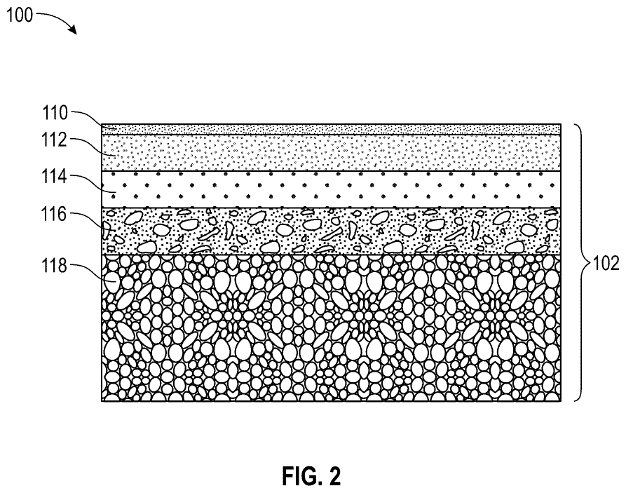

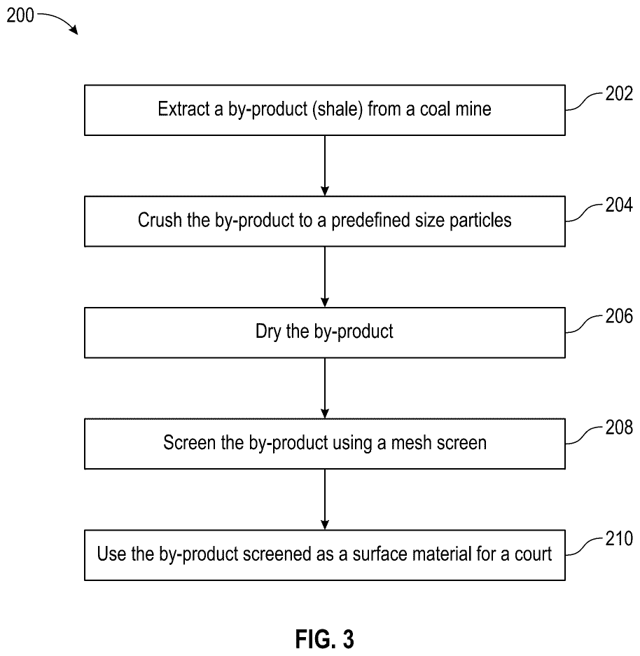

Various features and embodiments of extracting surface composition of clay-like athletic fields are explained in conjunction with the description of FIGUREs (FIGS. 2-3.

FIG. 2 shows a schematic view of a clay-like athletic field 100 having a plurality of layers 102, in accordance with one embodiment of the present invention. Examples of clay-like athletic field 100 include, but not limited to, a clay tennis court, pickleball court, track, and other athletic play surfaces. In one example, plurality of layers 102 include a first layer 110, a second layer 112, a third layer 114, a fourth layer 116 and a fifth layer 118. First layer 110 indicates a top layer. Second layer 112 indicates an under-layer that sits underneath first layer 110.

In accordance with the present invention, first layer 110 and/or second layer 112 consists of a coal shale. Here, the coal shale indicates a sedimentary rock that sits in a coal mine as a waste material for a prolonged duration, say several decades. With time, the sedimentary rock becomes an incombustible residue after it increasingly intersperses with shale and turns into coal shale. The sedimentary rock becomes impure and turns into a red clay with over exposure to the environment. The coal shale is repurposed to be used as surface composition for first layer 110 and/or second layer 112 in varied grain sizes. In other words, the coal shale includes a sedimentary rock exposed to environmental conditions for a prolonged duration resulting in an incombustible residue with a red clay appearance. The coal shale is crushed and screened to form fine grain particles for use as first layer 110 and/or second layer 112. The coal shale has the same characteristics or properties of the crushed red brick used in Europe.

In one example, second layer 112 has a thickness of 4 centimeters (cm) with a grain size larger than first layer 110. First layer 110 may have a thickness of 0.1 to 1 centimeters (cm) with a finer grain size. Second layer 112 possesses binding characteristics allowing first layer 110 to sit on it.

Third layer 114 indicates a ground layer that sits underneath second layer 112 with a thickness of 4 cm and a grain size of 2-15 mm. Fourth layer 116 consists of crushed aggregate and sits underneath third layer 114. In one example, the crushed aggregate has a thickness of 5 centimeters (cm) with grain size of 3-15 mm. Fifth layer 118 consists of loose stones that acts as foundation for clay-like athletic field 100. As can be seen, fifth layer 118 sits underneath fourth layer 116. In one example, fifth layer 118 has a thickness ranging from 20 to 30 cm with a grain size of 40-70 mm. The thickness of each layer is provided for illustrative purposes only and should not be construed in a limiting sense. A person skilled in the art may add or remove one or more layers and the thickness of each layer may vary, without departing from the scope of the present invention. All modifications fall within the scope of the present invention.

In the present invention, the burned-out coal shale is used as a playing surface (surface composition) i.e., first layer 110. Here, first layer 110 offers a playing surface with enhanced traction, similar to or better than traditional crushed brick. Optionally, burned-out coal shale is used as second layer 112 with a slightly larger grain size than first layer 110.

In one exemplary embodiment, clay-like athletic field 100 may include fifth layer 118 i.e., six (6) inches of compacted gravel. Here, the compacted gravel provides foundational support and enhance water drainage. Further, third layer 114 and/or fourth layer 116 may include one (1) inch of fine gravel to improve stability and prevent material displacement. First layer 110 and/or second layer 112 may include one (1) inch of screened red burnt coal shale. The coal shale is screened using industrial screening equipment (or a screen) to achieve a consistent and optimal particle size.

During the development of clay-like athletic field 100, a number of screen sizes/meshes were used to build several sample tennis courts. For example, small sample tennis courts, each measuring 2 feet by 2 feet squares were constructed using a sub-surface of 6 inches of gravel, 1 inch of fine gravel, and 1 inch of manufactured sand. At first, a relatively large screening size was used, Over time and exposure to environmental conditions, the shale particles moved to the surface, making the court unplayable. In the subsequent tests, the screen size was reduced further, which resulted in similar results. The screen size was reduced to about 1.5 mm and smaller. Here, the shale material was screened slowly (for prolonged retention in the screen), to improve particle uniformity. It was found that a screen size of 1.5 mm or less and screening at a slower rate produced a tennis court surface that compacted well and remained porous enough to allow rain to pass through quickly. Only a desirable amount of material shifted on the bed, which made a playable tennis surface.

Subsequently, a full size tennis court was constructed with the same sub surface composition as the smaller tennis courts explained above. The court was covered with one inch of the screened red burnt shale material, and compacted it with a roller, similar to a Rubico™ court. The resultant clay-like athletic field 100 offered playing characteristics similar to red clay court available in Europe. Further, the tennis court required very little maintenance compared with a traditional American red clay court or Rubico™ court.

From the above, it is clear that the coal shale having a size of 1.5 millimeter (mm) or smaller, when screened slowly, ensures uniform particle distribution. It should be understood that 1.5 mm particle size is exemplary and the coal shale having slightly different size may also be selected depending on the need, and such implementation falls within the scope of the present invention.

In addition, presently disclosed clay-like athletic field 100 made with the coal shale having a size of 1.5 mm at the surface compacts well and is porous enough to allow rain to pass through quickly. Even after rain, a small amount of the material of the coal shale shifts from the compacted surface, making it optimal for playing tennis. In other words, the slow screening results in a surface that compacts effectively and maintains sufficient porosity for water drainage in a short time period. The 1.5 mm particle size minimizes surface material migration, which creates a consistent playing surface. This reduces the need for excessive maintenance required to keep clay-like athletic field 100 in good condition when compared to typical tennis court.

During summer, clay-like athletic field 100 may require 10-15 minutes of watering, when compared to repeated watering of the green clay courts. Clay-like athletic field 100 maintains its integrity when compared with conventional courts, which are susceptible to cracking and gauging. As such, the presently disclosed clay-like athletic field 100 provides a cost-effective and high-performance alternative to traditional clay courts.

As discussed above, most clay tennis surfaces utilize crushed brick, referred to as “red clay”. However, the red clay is costly and is not readily available in regions such as the United States. Furthermore, traditional American clays that try to mimic the red clay courts seen in Europe have proven to be ineffective alternatives. In addition, no alternatives have existed to replace the traditional American clays or Rubico for clay-like athletic fields.

The present invention solves the problems by providing an alternative and novel surface material that provides enhanced moisture control and compaction properties when compared to traditional American clays or Rubico. The presently disclosed clay-like athletic field can be used in any region across the world. As presented above, the use of burned-out coal shale, when screened slowly to 1.5 mm or less, provides a playing surface with compaction and porosity. The resultant surface offers playing characteristics similar to European red clay courts and also requires less maintenance. This reduced maintenance addresses a long-felt need in the art to have a playable surface while presenting a cost-effective alternative to traditional clay surfaces. Traditional American clays and Rubico, mimicking the European red clay, have failed to deliver similar performance in moisture retention, playability, and low maintenance achieved by the present invention.

The prior art doesn't teach or suggest utilizing burned-out coal shale for clay-like athletic fields. The lack of prior teaching emphasizes the non-obvious nature of the present invention. Specifically, the prior art doesn't teach, suggest, or motivate the use of burned-out coal shale for clay-like sports fields that result in a surface providing surprisingly superior moisture retention, easy maintenance, and improved playing conditions for athletes.

Now referring to FIG. 3, a method 200 of extracting burned-out coal shale from a coal mine for use as surface composition for clay-like athletic field is explained, in accordance with one embodiment of the present invention. The order in which method 200 is described should not be construed as a limitation, and any number of the described method blocks can be combined in any order to implement method 200 or alternate methods. Additionally, individual blocks may be deleted from method 200 without departing from the spirit and scope of the invention described herein.

Method 200 starts at step 202. At step 202, a by-product i.e., coal shale is extracted from a coal mine. As specified above, the sedimentary rock that has undergone high-temperature combustion during the coal mining process and is left for a long period becomes a waste material and turns red in color due to prolonged exposure to the environment. The coal shale is collected from the coal mine using known mechanisms. At step 204, the coal shale is crushed to predefined size particles. As mentioned above, first layer 110 and/or second layer 112 consist of coal shale. After crushing, coal shale is dried for a predetermined time period, as shown at step 206. Subsequently, the dried coal shale is screened via mesh screens (not shown) of different grain sizes to separate the dried shale for use as first layer 110 and/or second layer 112, as shown at step 208. In one example, the mesh screen has a 4 mm thickness for screening surface material for use as first layer 110. In other example, mesh screen has a 1.5 mm thickness for screening surface material (coal shale). In some cases, the surface material is screened slowly i.e., screen for a longer duration to obtain uniform particle size. Subsequently, the coal shale is compacted using a roller and used as a surface material i.e., as first layer 110 and/or second layer 112 for clay-like athletic field 100, as shown at step 210.

The presently disclosed surface material extraction provides several advantages over the prior art. As known, typical crushed brick undergoes heating/firing prior to adding a binder or binding agent to it. The presently disclosed surface material (coal shale) does not have to undergo any heating treatment. Since the coal shale is exposed to the environment/sun for a long period of time, the coal shale becomes incombustible and turns red by itself. The coal shale is further crushed and screened to obtain grain particles of desired size for use as surface material for clay-like athletic fields (e.g., clay tennis courts).

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A clay-like athletic field, comprising:
a first layer; and
a plurality of foundation layers stacked underneath said first layer, wherein said first layer forms a surface layer, and wherein said first layer comprises a coal shale.

2. The clay-like athletic field of claim 1, further comprises a second layer positioned underneath said first layer.

3. The clay-like athletic field of claim 2, wherein said first layer has a thickness of 0.1 to 1 centimeters, and wherein said second layer has a thickness of 4 centimeters.

4. The clay-like athletic field of claim 3, wherein said plurality of foundation layers comprises a third layer, a fourth layer, and a fifth layer, wherein said third layer is positioned underneath said second layer, wherein said fourth layer is positioned underneath said third layer, and wherein said fifth layer is positioned underneath said fourth layer.

5. The clay-like athletic field of claim 4, wherein said third layer has a thickness of 4 centimeters.

6. The clay-like athletic field of claim 5, wherein said fourth layer comprises crushed aggregate, and wherein said fourth layer has a thickness of 5 centimeters.

7. The clay-like athletic field of claim 6, wherein said fifth layer comprises loose stones, and wherein said fifth layer has a thickness in the range of 20 to 30 centimeters.

8. The clay-like athletic field of claim 2, wherein said second layer comprises binding characteristics allowing said first layer to sit on it.

9. The clay-like athletic field of claim 2, wherein a grain size of said second layer is larger than a grain size of said first layer.

10. The clay-like athletic field of claim 9, wherein said plurality of foundation layers comprises a third layer, a fourth layer, and a fifth layer, wherein a grain size of said third layer is larger than the grain size of said second layer, wherein a grain size of said fourth layer is larger than the grain size of said third layer, and wherein a grain size of said fifth layer is larger than the grain size of said fourth layer.

11. The clay-like athletic field of claim 1, wherein said coal shale comprises a sedimentary rock exposed to environmental conditions for a prolonged duration resulting in an incombustible residue with a red clay appearance, and wherein said coal shale is crushed and screened to form fine grain particles for use as said first layer.

12. The clay-like athletic field of claim 1, wherein said clay-like athletic field comprises one of a clay tennis court and a running track.

13. The clay-like athletic field of claim 1, wherein said first layer is screened for a prolonged duration to obtain a particle size of 1.5 millimeter (mm), wherein said first layer is compacted while exhibiting porosity for water drainage.

14. A clay-like athletic field, comprising:
a first layer;
a second layer, wherein said second layer sits underneath said first layer;
a third layer positioned underneath said second layer;
a fourth layer positioned underneath said third layer; and
a fifth layer positioned underneath said fourth layer,
wherein said first layer indicates a surface layer,
wherein each of said first layer and said second layer comprises a coal shale, and
wherein said fifth layer acts as a foundation layer for said clay-like athletic field.

15. The clay-like athletic field of claim 14, wherein said second layer comprises binding characteristics allowing said first layer to sit on it.

16. The clay-like athletic field of claim 14, wherein a grain size of said second layer is larger than a grain size of said first layer, wherein a grain size of said third layer is larger than the grain size of said second layer, wherein a grain size of said fourth layer is larger than the grain size of said third layer, and wherein a grain size of said fifth layer is larger than the grain size of said fourth layer.

17. The clay-like athletic field of claim 14, wherein said clay-like athletic field comprises one of a clay tennis court and a running track.

18. The clay-like athletic field of claim 14, wherein said first layer has a thickness of 0.1 to 1 centimeters, wherein said second layer has a thickness of 4 centimeters, wherein said third layer has a thickness of 4 centimeters, wherein said fourth layer has a thickness of 5 centimeters, and wherein said fifth layer has a thickness in the range of 20 to 30 centimeters.

19. A method of providing a clay-like athletic field, said method comprising the steps of:
providing a first layer; said first layer being a surface layer;
providing a second layer, said second layer sitting underneath said first layer, each of said first layer and said second layer comprising a coal shale; and
providing a plurality of foundation layers stacked underneath said second layer.

20. The method of claim 19, further comprising:
extracting said coal shale from a coal mine;
crushing said coal shale to a predefined size particles;
drying said coal shale;
screening said coal shale using a mesh screen for a prolonged duration; and
compacting said coal shale screened for use as said first layer, said first layer exhibiting porosity for water drainage.
